(19) United States
(12) Patent Application Publication
(10) Pub. No.: US 2011/0114624 A1
(43) Pub. Date: May 19, 2011

(54) FOOD HOLDING CABINET POWER SUPPLIES WITH DOWNLOADABLE SOFTWARE

(75) Inventors: Terry Tae-IL Chung, Bartlett, IL (US); Michael Valentino, Geneva, IL (US); Jeff Schroeder, Lake Zurich, IL (US); Mark Kmiecik, Chicago, IL (US); David Reid, Palatine, IL (US); Paul Berland, Elgin, IL (US); Kerry Berland, Chicago, IL (US); Douglas Reinking, Chicago, IL (US)

(73) Assignee: PRINCE CASTLE, INC, CAROL STREAM, IL (US)

(21) Appl. No.: 12/618,957

(22) Filed: Nov. 16, 2009

(51) Int. Cl. F27D 11/00; H05B 1/00

(52) U.S. Cl. 219/385; 219/482

(57) ABSTRACT

A universal food holding cabinet has multiple compartments, the temperatures of which are under software control by microprocessors or microcontrollers located on power supply circuit boards for corresponding compartments. Each compartment can have different temperature control requirements with different requirements being met by different programs in different processors, or different operating parameters for the same program. The cabinet is configured to prevent the power supply boards from being installed incorrectly, to provide an address to a power supply circuit board when it is installed and by which a power supply circuit can be addressed by a master controller to receive downloads of executable instructions and/or data.

### BACKGROUND

Many restaurants' success depends on how quickly customers can be served with food items that a customer orders. If the rate at which a restaurant cooks food products equals the rate at which those same food products are being ordered and sold, a fast food restaurant can theoretically have freshly-cooked foods ready to serve for customers as they arrive. Since it is not always possible to match cooked-food production with customer ordering rates, and since fast food restaurant customers expect to receive their ordered food items quickly, many fast food restaurants pre-cook various food items and keep them warm, ready for sale until a customer arrives and purchases a pre-cooked food item.

Pre-cooked food items cannot be stored for prolonged periods and must be kept warm while they are being held. Prolonged heating causes food texture and flavor to deteriorate. The time that a food product can be kept warm yet remain palatable will vary with each type of food product. It is therefore beneficial to have an ability to store different types of foods at different temperatures and keep track of the time that a food has been kept warm.

Food holding cabinets are well known in the prior art. A problem with prior art food holding cabinets, as with most commercial restaurant equipment is that they sometimes fail and require a service technician to repair. In keeping with food service operators' goal of reducing cost, it would be desirable to provide on-site service ability to a food holding cabinet whereby repairs can be effectuated by a restaurant operator, on-site and without having to call a service technician.

### BRIEF DESCRIPTIONS OF THE DRAWINGS

Preferred embodiments are set forth in the following detailed description and accompanying drawings in which like reference numerals represent like parts.

FIG. 1 is a perspective view of a universal food holding cabinet with snap-in escutcheons;

FIG. 2 is a front view of the oven depicted in FIG. 1, with the top panel removed;

FIG. 3 is a rear view of the oven depicted in FIG. 2;

FIG. 4 is a perspective view of the rear of the oven shown in FIG. 3 with the uppermost escutcheon removed from the rear face of the oven, and showing the oven's right-side panel (when viewed from the front) removed to reveal the right side of the oven chassis and attachment points of the escutcheons;

FIG. 5 is a perspective view of the front of the oven shown in FIG. 3 with the uppermost escutcheon removed from the front face of the oven, and showing the oven's left-side panel removed to reveal the right side of the oven chassis and attachment points of the escutcheons;

FIG. 6 is an isolated, perspective view of a control board that carries electronic devices that control heat transfer elements and which are coupled to user interfaces on the cabinet escutcheons;

FIG. 7 depicts the control board of FIG. 6, partially removed to reveal connectors on the circuit board and connectors on a mother board for the cabinet;

FIG. 8 is a perspective view of the right side of the cabinet as viewed from the rear; and

FIG. 9 is a block diagram of electronics in the cabinet.

### DETAILED DESCRIPTION

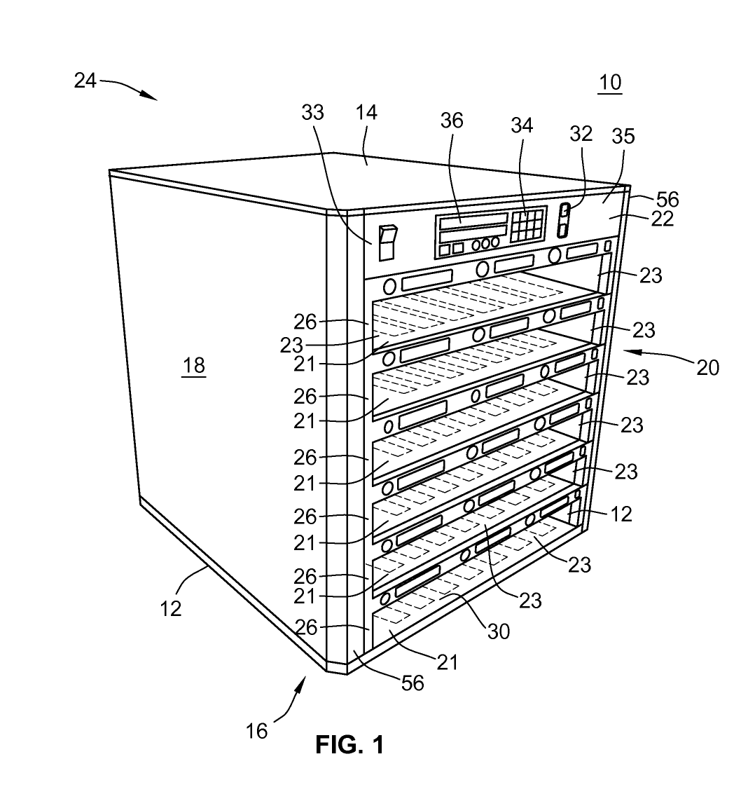

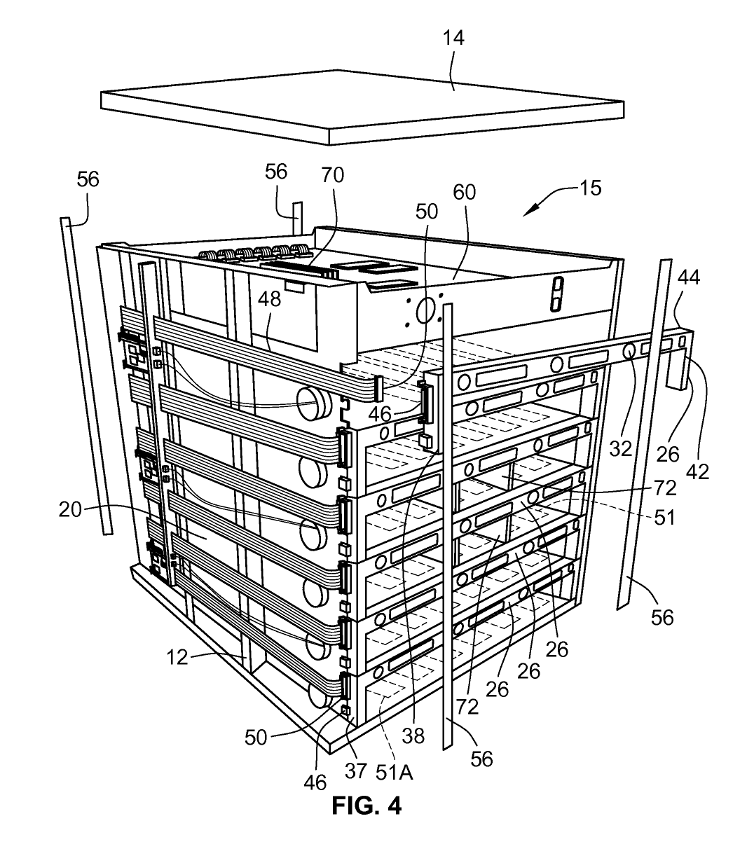

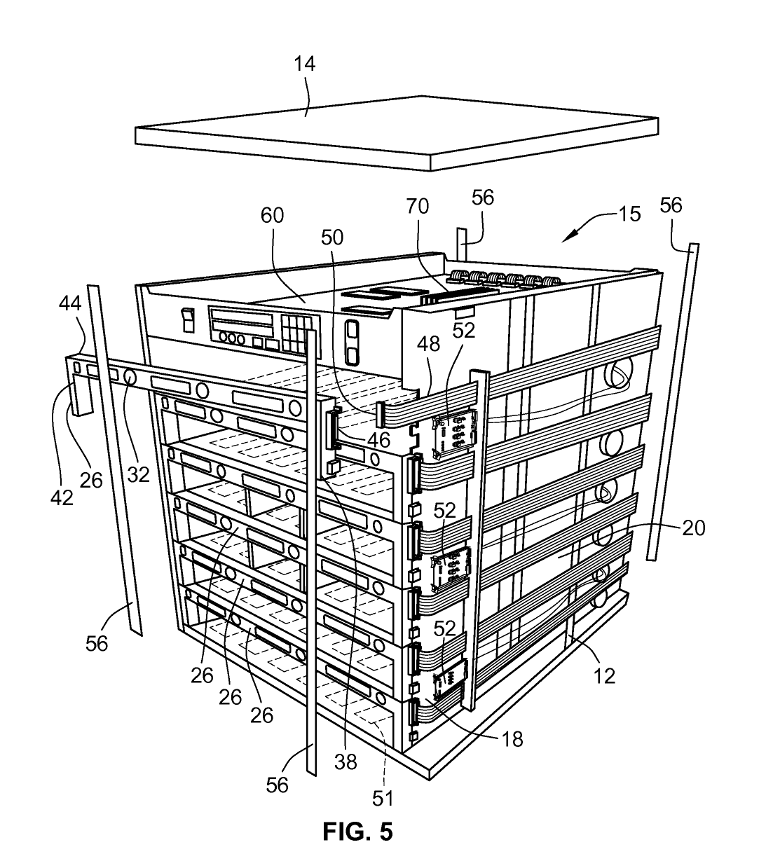

FIG. 1 is a perspective view of a temperature-controlled food holding cabinet 10. The holding cabinet 10 is comprised of a metal frame or chassis 12, best seen in FIG. 4 and FIG. 5. The chassis 12 is comprised of various stamped and/or rolled metal components that form a substantially cube-shaped oven-like cabinet subdivided into several separate, temperature-controlled food-holding compartments 23. Depending on the placement of heating and cooling elements as described more fully below, each shelf 21 is capable of maintaining one or more different temperatures for different types of food items.

As can be seen in FIG. 1, the cabinet 10 is comprised of a top panel 14, a bottom panel 16, a left-side 18, a right-side 20, a front face 22 and a rear face 24 not visible in FIG. 1. The top panel 14 covers electronic components, which include a master controller computer 70, (not shown in FIG. 1) cables and connectors (not shown in FIG. 1), which provide electrical connections user interface devices, peripheral slave computers described below and the master controller. A top panel 31 of the front face 22 provides several user interfaces by which a cabinet operator can configure the cabinet 10 but also quickly determine its status by visually reading corresponding user interfaces. As can be seen in FIGS. 4 and 5, the side panels cover the left and right sides and electronic circuits and associated wiring adjacent the cabinet's sides.

The front face 22 and the rear face 24, are provided with snap-into-place bezels, which are also referred to herein as snap-in escutcheons or simply escutcheons, identified in the figures by reference numeral 26. As described more fully below, the escutcheons 26 cover the edges 25 of the shelves 21. They also define openings into food storage compartments 23. And, the escutcheons 26 provide user interface devices, which include display devices and user-actuated control devices, the function and operation of which is described more fully below.

Importantly, the escutcheons 26 used on both the front and rear faces of the cabinet 10 and are interchangeable. The escutcheons 26 are thus configured to have electrically parallel electrical connectors 46 at each end of the escutcheon 26, which mate with chassis-located connectors 50 described more fully below but preferably located to one side of each cabinet face.

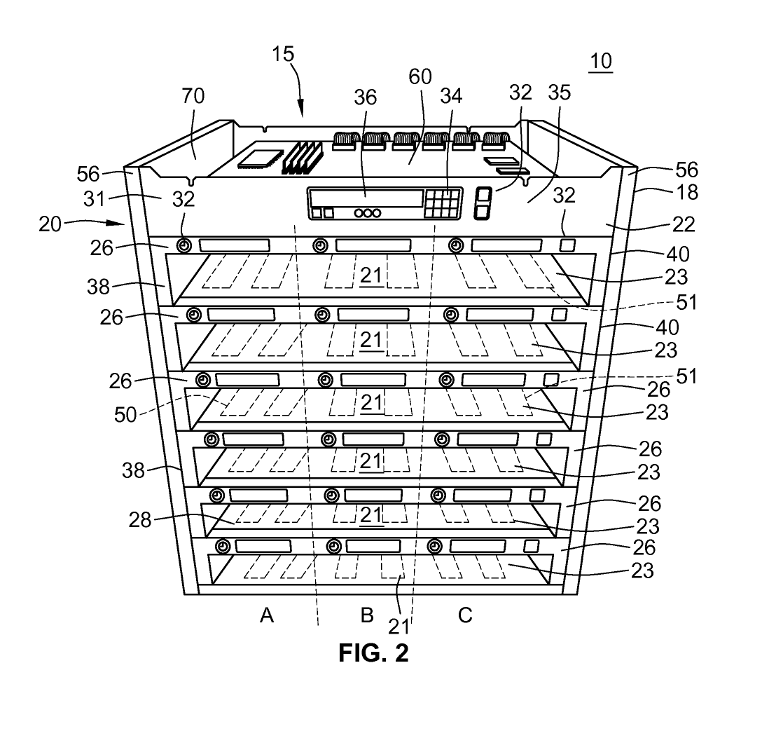

FIG. 2 is a front view of the cabinet 10 with the top panel 14 removed to reveal cabinet electronics equipment in the cabinet's electronics compartment 15, which is covered and protected by the top panel 14. The electronic equipment in the electronics compartment 15 includes at least one “master” computer/controller 70, for other electronics in the cabinet 10.

Below the electronics compartment 15 are several horizontal and substantially planar, thermally-conductive shelves 21. The shelves 21 are vertically separated from each other in the chassis 12 and fixed between the left side 18 and right side 20 to define food-holding compartments 23. The vertical separation distance between each shelf 21 defines the height of each compartment 23 and thus the maximum height of a food item or the packaging for a food item.

The shelves 21 and the compartments 23 are considered to extend horizontally across most of the width of the cabinet 10. The shelves 21 are preferably made from thermally conductive materials such as aluminum, copper or steel, so that the temperature of the food holding compartments 23 can be maintained by the transfer of heat from the shelf 21 into the compartment 23, or from the compartment 23 into the shelf 21. Different types of temperature control elements 51 are embedded into each shelf 21 or otherwise thermally coupled thereto. Compartment temperature can thus be achieved by controlling the temperature of the temperature control elements 51, which in turn controls the temperature of the thermally conductive shelves 21 defining the compartments 23 thus effectively determining compartment temperature.

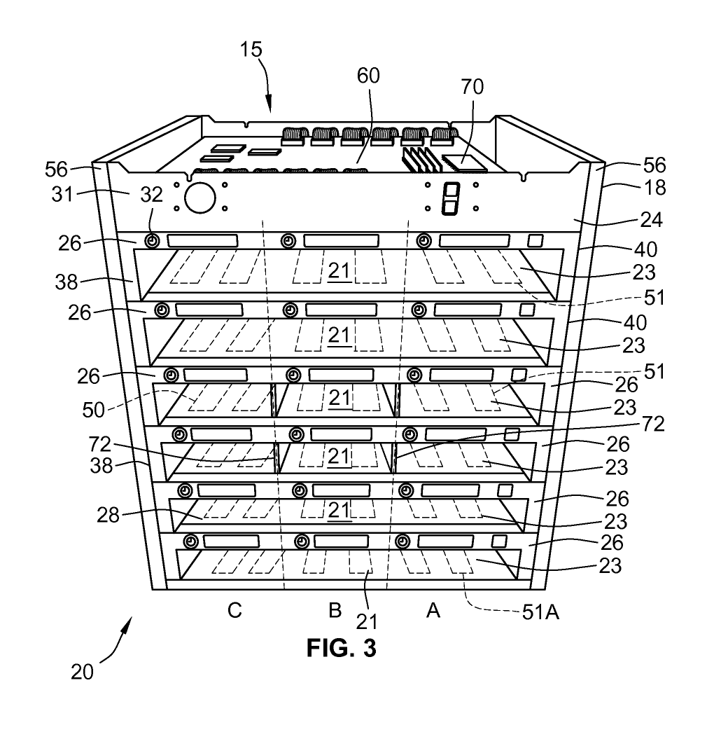

In a preferred embodiment, the shelves 21 of the cabinet 10 are open between the sides 18 and 20 and the front face 22 and rear face 24 but are nevertheless considered to be horizontally subdivided into temperature-controlled zones. The different zones for each shelf are identified in FIGS. 2 and 3 by broken vertical lines bracketing the letters A, B and C near the bottom 16 of the cabinet 10. When the cabinet 10 is viewed from the front, as shown in FIG. 2, the “A” zone of each shelf is at the left-hand side of the cabinet 10; the “C” zone is locate on the right-hand side of the cabinet 10; the “B” zone is located between the A and C zones. Temperature control of the separate zones A, B and C is accomplished by using separate temperature control elements 51 constructively “in” a zone and which are thermally coupled preferentially to one zone. By way of example, zone A in a first shelf has a temperature control element 51A embedded in the shelf and centered in the “A” zone. The temperature control element 51A therefore provides most of its heat output or heat sinking in the A zone of the shelf 21.

A temperature control element such as a heater 51 embedded in the shelf 21 and centered in the “A” zone is separately controlled from other temperature control elements or heaters 51 embedded in the same shelf 21 and centered in zones B and C. In an alternate embodiment, zones A, B and C and corresponding embedded heaters 51 are thermally isolated from each other using a thermal break, such as those disclosed in co-pending application Ser. No. 12/267,449 entitled, BIFURCATED HEATED TOASTER PLATEN, which is assigned to the assignee of this application. The content of the co-pending application Ser. No. 12/267,449 is incorporated herein by reference, at least with regard to heated platens and the thermal breaks disclosed therein. In yet another embodiment, the zones are isolated from each other by vertical dividing walls 72 that extend between the top and bottom of shelves 21 defining a compartment 23 between them.

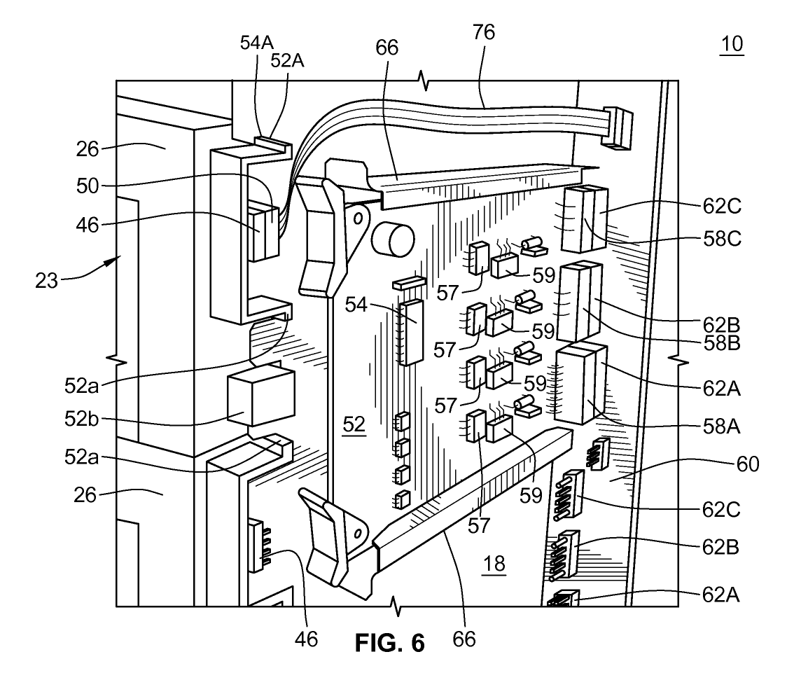

FIG. 6 is an isolated, perspective view of one of the control boards 52 that carry electronic devices, that control one or more heat transfer elements 52 in a shelf or thermally coupled to a shelf 21 and that defines a temperature-controlled, food holding compartments 23 of the cabinet 10. The circuit board 52 is comprised of a computer 54, preferably embodied as a single-chip microcontroller having re-programmable RAM, EEPROM (electrically eraseable, programmable read only memory) on the same die as a CPU. The computer 54 typically has an address, data and control bus by which the CPU of the computer 54 communicates with devices that are peripheral or external to the computer. Address, data and control lines or busses are well-known to those of ordinary skill in the computer and electronics arts. The computer 54 also preferably has on the same die, a serial and/or parallel communications interface or “port” through which the computer 54 can communicate with other devices in the cabinet 10 or outside the cabinet via the bus 76 described more fully below.

In an alternate embodiment, the circuit board 52 includes a microprocessor and one or more external memory devices coupled to the microprocessor's address, data and control lines using well-known, conventional methods and devices. For reasons set out below, external memory devices coupled to a microprocessor are preferably embodied as EEPROM or equivalent, in order to enable the storage of new program instructions and/or data for the computer 54, as set forth more fully below.

In addition to the computer 54, the circuit board 52 includes either high power field effect transistors (FETs), silicon controlled rectifiers (SCRs), TRIACs or relays, or a mixture of such devices to effectuate the control of electric energy to heat transfer devices 51. Semiconductors as well as mechanical relays used to control electricity provided to the heat transfer elements 51, are collectively referred to herein as current-controlling semiconductor devices and identified in the figures by reference numeral 59, even though relays are generally considered to be mechanical devices.

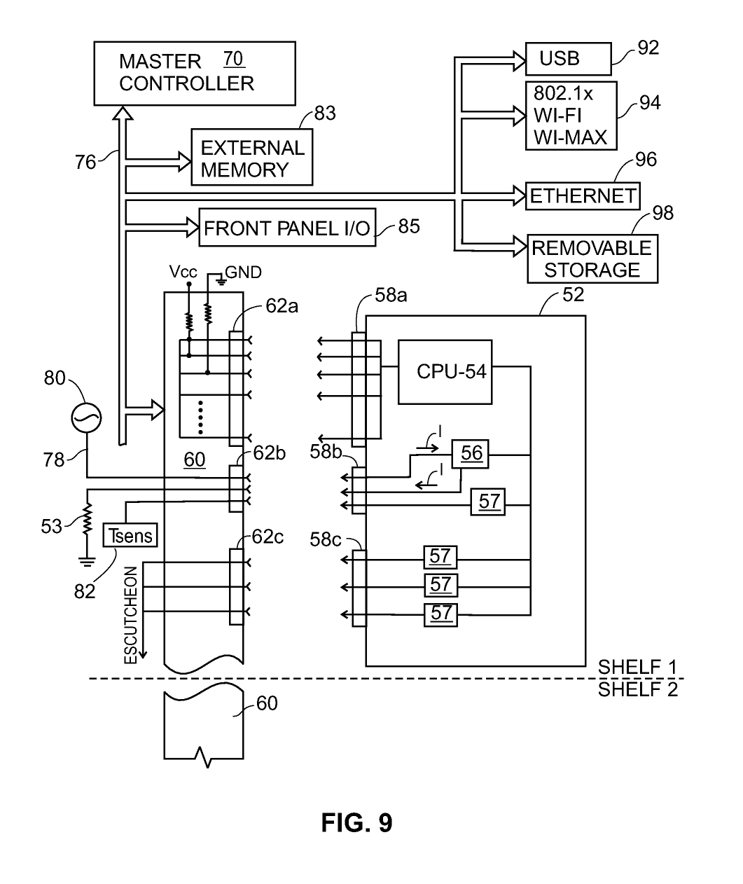

The current-controlling semiconductors 59 (current control devices 59) are electrically coupled between an external power source 80 (See FIG. 9.) and a heat transfer element 51. The heat transfer elements 51 used in the cabinet 10 include heating elements embedded into shelves as shown in FIGS. 2 and 3 or attached to the shelves' top or bottom surfaces. Heat transfer elements 51 also include Peltier devices, as disclosed in the applicants' co-pending patent application entitled, UNIVERSAL FOOD HOLDING CABINET HAVING SNAP IN ESCUTCHEONS, having Ser. No. 12/618,939, filed Nov. 16, 2009, the entire contents of which are incorporated herein by references. The 12/618,939 application and this application are assigned to the same entity.

In addition to current control devices 59, the circuit board 52 includes other interface circuitry 57 to interface (electrically couple) the computer 54 to the aforementioned user interfaces in the escutcheons 26 as described above and in the aforementioned co-pending application. Such circuits 57 also include electrostatic discharge (ESD) suppression devices to enable the circuit boards 52 to be inserted into and removed from the cabinet without having to power the cabinet down. Stated another way, ESD suppressors imbue the ability to “hot swap” the circuit boards 52.

Circuits and devices that interface a computer to an LED, LCD display, electronic paper, bulbs, switches, temperature sensors and keyboards are well known in the art. Such devices are too numerous to name but include devices such as analog-to-digital (A/D) converters, digital-to-analog converters, display drivers and the like. There are many devices that couple a computer to a peripheral device and a description of them is omitted for brevity. Regardless of how signals from peripherals to the computer 54 are coupled to it, analog and digital, information-bearing signals exchanged between devices in the cabinet, e.g., user interfaces in the cabinet 10 and in the escutcheons, sensors, and the computer 54, determine how the computer's program instructions, when executed, effectuate temperature control of a compartment 23.

The current-controlling semiconductor devices 56 receive control signals from the computer 54 such that signals from the computer 54 modulate or switch the current to the temperature control devices 50 in the cabinet. The control signals that the computer 54 send to the semiconductor devices 56 are determined by the computer's executable program instructions as well as data (non-executable) stored in memory and, in some instances, signals the computer 54 receives from devices in the cabinet 10, including temperature sensors 82 (See FIG. 9). The stored program instructions and/or data in memory, and/or provided to the computer 54 from the cabinet 10, thus determine how current is to be delivered to the heat transfer elements 51 and thus the temperature inside the compartments 23. Changing the program instructions in the computer 54 and/or changing data in the computer 54 thus enables changing how the computer 54 controls the semiconductor devices 56, and in turn, the temperature or other condition inside a compartment 23.

In FIG. 6, the circuit board 52 is shown as having three separate connectors 58 located at one edge of the circuit board 52. The different connectors 58 on the circuit board 52 are identified by reference numerals 58A, 58B and 58C. The connectors 58 mechanically and electrically engage and mate with corresponding connectors 62 that are electrically and mechanically attached to a motherboard 60 mounted orthogonally to the sidewall 18 of the cabinet 10.

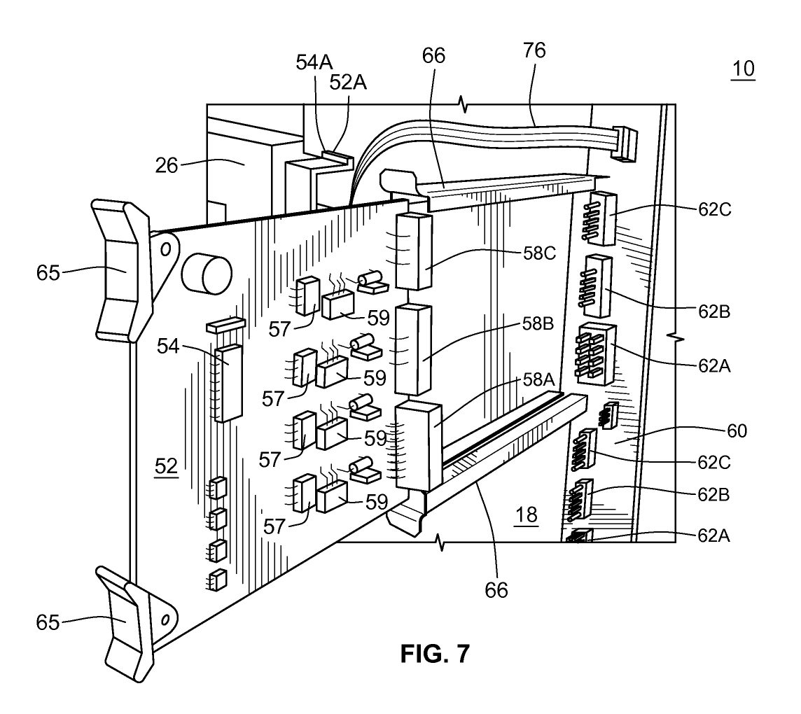

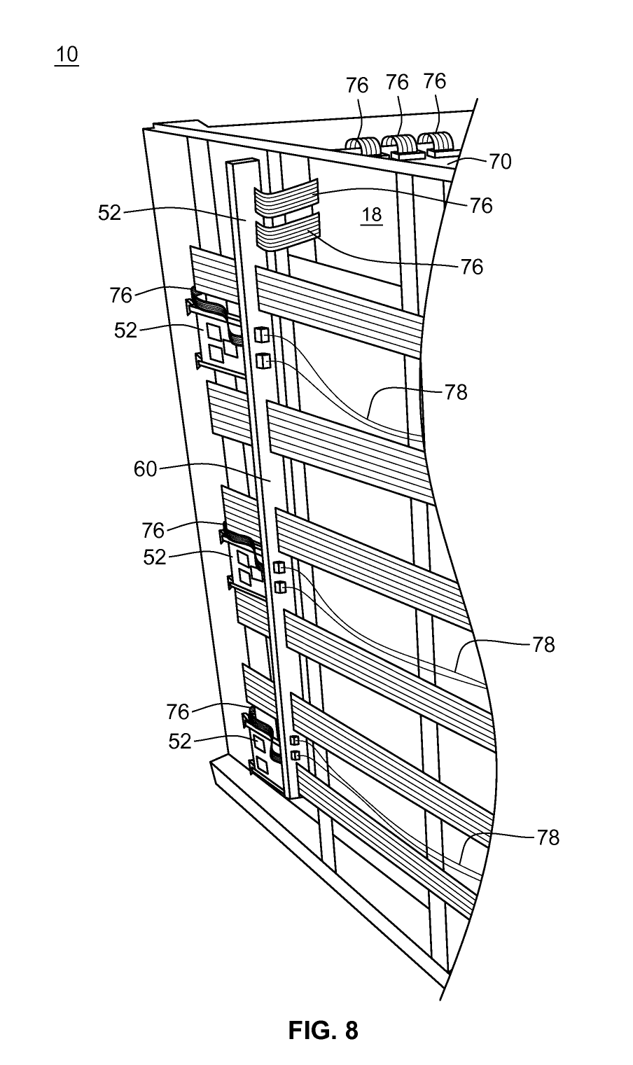

The motherboard 60 is elongated and provided with multiple sets of connectors 62 to enable multiple circuit boards 52 to be connected to it. Conductors inside ribbon cable 76 and other wires not shown in FIG. 7 but visible in FIG. 8, are connected between contacts on the motherboard 60 (contacts not shown), a master controller 70 for the cabinet 10, heat transfer devices 51, and user interfaces on the escutcheons 26 and cabinet 10. The connectors 58 and 60, motherboard 60, ribbon cable 76 and other wires thus enable signals to be exchanged between the computer 54 and other devices on the circuit board 52 and devices external to the circuit board 52.

Devices external to the circuit board 52 include temperature control elements 51, user interface devices in the escutcheons, temperature sensors and a master controller 70 in the electronics compartment 15. Alternate and equivalent embodiments of the circuit board 52 use, one, two or more connectors, not shown in the figure. Still other embodiments use circuit board edge connectors, well known to those of ordinary skill in the electronics and computer arts. For purposes of simplicity and brevity, connectors of any kind that enable the electrical connection of devices on the circuit board 52, to devices external to the circuit board 52 are collectively referred to herein interchangeably as either a connector or an edge connector.

As shown in FIG. 7, a circuit board 52 is slid on its side edges into grooves 53 formed into opposing sides of two brackets 66, which are themselves mechanically attached to the motherboard 60 to extend orthogonally away from the motherboard 60. The brackets 66 are spaced apart from each other and the grooves 53 deep and wide enough to allow the circuit board 52 to freely slide in and out of them. The brackets 66 thus removably support the circuit boards 52.

The brackets 66 are separated from the sidewall 18 of the cabinet 10 by a small distance such that the height of electronic components on the circuit board 52 and/or a connector 58, will not clear the sidewall 18 if the circuit board 52 is inserted into the brackets with the component side of the circuit board facing the cabinet sidewall 18. The location of the brackets on the mother board 60 relative to the cabinet sidewall 18 thus prevents the circuit board 52 from being inadvertently inserted upside down, i.e. in an improper orientation. The brackets 62, in combination with the cabinet sidewall 18 effectively form a card cage 64 that prevents the circuit boards 52 from being installed incorrectly into the motherboard 60. The brackets 66 and cabinet sidewall also make the circuit boards 52 “self-aligning” with respect to the connectors 62 on the motherboard 60.

FIG. 8 is a perspective view of the right side 18 of a preferred embodiment of the cabinet 10, as viewed from the rear 24 of the cabinet 10. Ribbon cables 76 can be seen connected between the mother board (connections on the mother board not visible but well known to those of ordinary skill) and a master controller/computer 70 located in the electronics compartment 15. Conductive circuit “traces” on the mother board carry electrical signals from the ribbon cable conductors, to various terminals of various connectors 62, into which the aforementioned circuit boards 52 are installed. (The conductive traces or paths on the mother board 60 are not visible in the figure but such traces are well known to those of ordinary skill in the electronic arts.) The ribbon cables 76 carry various signals that include address signals, data signals and control signals exchanged between the master controller 70 and a computer 54 on a circuit board 52 connected to the mother board 60. They also carry signals to other devices that are peripheral to the master controller 70, as shown in FIG. 9. The ribbon cables 76 are considered herein to both provide and act as a “bus” between the master controller 70 and various computers 54 to which the bus is connected to.

The concept of a bus carrying digital signals between a computer and devices peripheral to the computer, is well known to those of ordinary skill in the computer and electronic arts. Since the functionality of the bus is effectuated by the ribbon cables (and equivalents thereof), for purposes of simplicity, the terms “bus” and “ribbon cable” are thus used interchangeably hereinafter. For purposes of clarity, both of them are identified by reference numeral 76.

The computer 54 on the circuit board 52 is responsive to commands it receives from the master controller 70 over the bus 76. It is also responsive to information and inputs it receives from devices peripheral to it, such as escutcheon-located user interface devices and one or more temperature sensors, not shown. In a preferred embodiment, the computers 54 on the control boards 52 are thus considered to be “slaved” to the master controller 70.

As shown in FIG. 5, a preferred embodiment of the cabinet 10 has multiple circuit boards 52, each of which has at least one computer 54. In a preferred embodiment, each circuit board 52 controls the temperature control elements for two different shelves.

Each computer 54 on each circuit board 52 is coupled to the bus 76 such that each computer 54 “sees” all of the “information” on the bus 76. The master controller 70 selectively communicates with a particular slave computer 54 using an address that each slave computer 54 obtains from the mother board 60 (or a connector 62). The address obtained from the mother board 60 corresponds to a shelf or shelves that a circuit board 52 will control.

In a preferred embodiment, the communications between computers is via a serial communications protocol reminiscent of Ethernet. Messages from a sender are broadcast on the bus. Broadcast messages are received and selectively acted upon by the recipient to which a message was addressed.

Packets sent over the bus include a field that identifies the source of a packet by the logical address of the sender and a second field that identifies the recipient of the packet by its logical address. A packet payload contains all or part of a message being sent from the sender to the recipient. The addresses used by the master controller 70 and the slave computers 54 to communicate with each other are the addresses obtained from the mother board 60.

The address of a particular card cage and thus a computer 54 on a circuit board 52, is effectuated by electrically connecting various pins of the connector 62 to either V_{cc} or ground, which represent logic 1 and zero respectively. When the connectors 58 on the circuit board 52 engage the connectors 62 on the mother board 60, executable program instructions stored in memory for the computer 54, cause the computer 54 to “read” its logical address from the connectors 58/62. In an alternate and equivalent embodiment, signal leads on the mother board 60 apply voltages of V_{cc} or ground to pins of the connectors 62 installed into the mother board 60. In yet another embodiment, so-called DIP switches are used on the circuit boards 52 instead of connectors and configured “on” or “off” to provide a card cage address to the computer 54.

FIG. 9 is a block diagram of electronic devices that control the cabinet 10. The master controller 70 communicates with electronic devices located on control circuit boards 52, through a computer or “CPU” 54 on each circuit board 52. The master controller 70 and the slave computers 54 communicate with each other via the bus 76.

Conductors in the ribbon cable that comprises the bus are connected to various terminals or connection points on the motherboard 60. Conductive paths or “traces” on the motherboard, carry the signals on the ribbon cable, to different terminals of different connectors 62A, 62B and 62C.

In a preferred embodiment shown in the figure, a first pair of connectors 62A and 58A that connect to each other, convey signals between the controller 54 and the master controller 70. Three conductors are three address lines, which are identified by reference numeral 84. Two of the address lines 84 are shown as being “pulled-up” to V_{cc}. One address line 84 is “pulled down” to ground through a pull down resistor. The voltages on the three address lines 84 correspond to a binary-valued or digital address of “011” or “110” depending on which line is considered to be the least significant bit and/or most significant bit of a three-bit address space, i.e., addresses ranging from zero through seven inclusive.

When a control circuit board 52 is inserted into the card cage for shelf 1 and the connectors 58 & 62 engage, the controller 54 on the circuit board 52 can scan the address of the card cage/shelf to determine the address that it will use on the bus 76. The slave controller 54 thus determines which shelf it is responsible for controlling. Communications between that slave controller and the master controller 70 use the address obtained from the mother board.

Hard-wiring an address for a particular shelf of the cabinet enables software in the controller 54 to determine where it is installed and how it is to operate. It also allows control boards 52 to be generic, i.e., non-specialized.

Shelf 1 could be used to keep certain types of foods at a high temperature. A different shelf could be required to kept cold. Imbuing the control boards 52 with the ability to read their locations on the mother board enables the master controller 70 to flexibly control the cabinet 10 by controlling what the slave computers 54 are able and/or permitted to do.

In FIG. 9, a second pair of connectors 58B & 62B provide connections between the power supply devices 56, an external power source 80 and heat transfer elements 51. An interface 57 couples a temperature sensor 82, to the CPU 54. A third connector set 58C & 62C couple signals to and from the escutcheon 26 through other interface devices 57 which are themselves coupled into the CPU 54.

The master controller 70 is depicted as being connected to an external memory device 83 via the bus 76. The master controller 70 includes software, which when executed by the controller 70, maintains the temperature of compartments 23 by controlling the slave computers 54, directing each of them as needed to keep all the compartments' temperatures relatively constant in order to keep a food item at a substantially constant temperature. The master controller 70 also maintains the time that a food item has been kept in a compartment, which is determined by a user's actuation of a switch or other input/output device on an escutcheon 26, the actuation of which is read initially by a slave computer 54 and then passed to the master controller 70 over the bus.

Time periods that a food item is kept in a compartment are compared against time limits for the food item. Such time limits can be user-specified through the front panel input/output (I/O) 85.

Those of ordinary skill in the art will recognize from the foregoing description that food items in a multi-compartment food holding cabinet can be kept at a constant temperature by appropriately controlling heat transfer elements such as electric heaters. In the apparatus described above, the method includes downloading to a first slave computer from a master computer, data or executable program instructions that control the slave computer's control over heat transfer devices. The data and/or instructions downloaded to one slave computer can optionally be different from the data and/or instructions downloaded to a second computer. The determination of which set of instructions to download to the power supplies 52 can be made using an operating parameter for a compartment 23 that the power supply is connected into via the motherboard 60.

Data downloaded to the slave computers can be data that specifies a holding temperature for the first compartment, a holding time limit for a food item, operational instructions, i.e., instructions to display to a user as to how to operate the cabinet, an elapsed time for a food item held in the first compartment and/or the identity of a food item in a first compartment.

Those of ordinary skill in the art will recognize that the master controller 70 is preferably a single chip microcontroller with its own on board RAM, ROM and EEPROM. The bus also couples the master controller 70 to the cabinets' front panel input/output-user interface devices described above. Finally, the master controller 70 is also coupled to various communications devices through which the master controller 70 can communicate with the outside world. The interfaces for external communications include a USB port 84, and 802.1x (wifi or wimax) wireless interface 86 as well as an Ethernet interface 88, removable storage device such as a CD or DVD drive, SIM cards or other removable storage media. The external communication interfaces 84, 86 and 88 enable the master controller 70 to receive executable program instructions and data for either the master controller 70 or the slave CPU 54.

In a preferred embodiment, memory onboard the master controller die, includes memory that stores executable program instructions for the slave computer 54 as well as data. In an alternate embodiment, the executable program for the slave computer 54 and data can also be stored in the external memory 83.

Storing the program executed by the slave computer 54 in the master controller provides several benefits. Firmware for the slave computer 54 can be kept up-to-date by acquiring new programs via one or more of the external communications interfaces. It also allows the firmware for the slave computer 54 to be changed based on customer requirements or food holding requirements.

In a first embodiment, the slave computer 54 on the circuit board 52 is pre-programmed with only a small program, which reads the address of the shelf wherein it is located from the mother board 60. Other instructions issue a request to the master controller 70 via the bus, asking the master controller 70 for a download of instructions that will give the slave controller 54 its “personality.” In yet another embodiment, the slave computer 54 is pre-programmed with enough code for it to notify the master controller of its presence on the bus and to thereafter wait for a download from the controller 70. In yet a third embodiment, all of the operating instructions are burned into the slave computer 54, however, operating parameters such as temperatures to maintain a compartment at, or food holding time limits are downloaded from the master controller 70 or received through one or more of the user interfaces. In yet another embodiment, the slave computer 54 is pre-programmed with sufficient instructions that enable it to take control of the bus 76 and download its operating program and/or data from the external memory under its own control. Once the program instructions are down loaded from the external memory, the slave computer 54 can thereafter operate autonomously, subject of course to the control instructions it receives from the master controller. Microprocessors that embody the master controller 70 and the slave computers 54 are different types of devices, however, alternate embodiments use the same microprocessor for both the master and slave functions.

In most implementations, a particular program is required to control heating elements for the shelves. A separate and different program is required to control Peltier devices that refrigerate and/or heat one or more compartments.

It should be noted that the download provided to the slave computer 54 includes software that reads and controls the user interfaces in the escutcheons for a particular shelf. Such software includes instructions and data to display information to an operator.

In yet another embodiment, the downloaded software includes diagnostics that can test devices on the circuit board 52 as well as the functionality of heat control elements 50, temperature sensors 82.

Master/slave communications over the bus 76 include: downloading commands to the slave computers 54 from the master controller; uploading commands/requests from the slave computers 54 to the master controller; downloading operating parameters, i.e., data to the slave computers from the master controller; uploading collected data from the slave computers 54 to the master controller; and, downloading executable program instructions from the master controller to one or more of the slave computers 54, which when loaded into a slave computer, change the operating characteristics or “personality” of a slave computer 54 into which the new program instructions are installed. The master controller 70 can either demand the slave computer 54 to accept a download or receive a request for a download from a slave computer 54.

In a preferred embodiment, the download is requested by the slave computer 24. In an alternate embodiment, the slave computers 54 are able to seize control of the bus 76 and autonomously download instructions and/or data from either the external memory 83 or from one or more of the external communications devices 92, 94, 96 and/or 98.

The foregoing description is for purposes of illustrations only. The true scope of the invention is set forth in the appurtenant claims.

What is claimed is:

1. A temperature-controlled food holding cabinet (food holding cabinet), the food holding cabinet comprised of:
an electrically-powered heat transfer element (element) thermally coupled to a food holding compartment (compartment);
a computer controlled power supply for the element, the power supply being comprised of:
a first computer (first computer), which executes program instructions stored in a memory device;
a first memory device coupled to the first computer and storing executable program instructions for the first computer therein;
an electrical power control device coupled to:
an electric power source;
the first computer; and
the element;
the electrical power control device controlling electric power delivered to the element from the electrical power source in response to at least one signal received from the first computer; and
a second computer operatively coupled to the first computer, the second computer being capable of obtaining of providing to the first computer as a download, at least one of:
data; and
executable program instructions for the first computer.

2. The food holding cabinet of claim 1, wherein the first computer and the second computer are different types of computers.

3. The food holding cabinet of claim 1, further comprised of a computer bus configured to carry information-bearing signals between the first and second computers.

4. The food holding cabinet of claim 1, wherein the second computer is operatively coupled to the first memory device through the first computer.

5. The food holding cabinet of claim 1, wherein the electrical power control device is at least one of:
a semiconductor; and
an electromagnetic relay.

6. The food holding cabinet of claim 2, wherein the second memory device coupled to the second computer, stores at least one of:
data, for the first computer; and
executable program instructions, for the first computer.

7. The food holding cabinet of claim 1, wherein the first computer and the first memory device are co-located on the same semiconductor die.

8. The food holding cabinet of claim 1, wherein the first computer is configured to receive a download from the second computer, the download being provided to the first computer in response to at least one of:
a download request sent from the first computer to the second computer; and
a download command sent from the second computer to the first computer.

9. The food holding cabinet of claim 8, wherein the download is stored in the first memory device, under the control of the first computer.

10. The food holding cabinet of claim 8, wherein the download is stored in the first memory device, under the control of the second computer.

11. The food holding cabinet of claim 8, wherein the second computer is configured to pass the download to the first computer, through the second computer prior to sending it to the first computer.

12. The food holding cabinet of claim 1, wherein the first computer is configured to control temperature for the compartment according to data received by the first computer in a download.

13. The food holding cabinet of claim 1, wherein the first computer is configured to control temperature for the compartment according to executable program instructions received in said download.

14. The food holding cabinet of claim 1, wherein the element is a resistive heating element.

15. The food holding cabinet of claim 1, wherein the compartment is a heated compartment.

16. The food holding cabinet of claim 1, further comprised of a temperature sensor thermally coupled to the compartment, the first computer receiving a signal from the temperature sensor representative of a temperature inside the compartment and controlling electric power to the element in response thereto.

17. The food holding cabinet of claim 1 further comprised of a timer configured to determine the time that a food item has been in the compartment.

18. The food holding cabinet of claim 17, wherein the timer is comprised of one of instructions executed by at least one of the first computer and the second computer.

19. The food holding cabinet of claim 1, further comprised of a first user interface, operatively coupled to the second computer, the first user interface being configured to display at least one of:
the temperature of the compartment;
the time that a food item has been inside the compartment;
the time that a food item should remain inside the compartment;
the identity of a food item in the compartment;
operational instructions;
diagnostic information; and
an expiration notice that the food can no longer be used.

20. The food holding cabinet of claim 1, wherein the bus is a serial bus.

21. The food holding cabinet of claim 1, wherein the first and second computers are configured to communicate on the bus using an address broadcast on the bus.

22. The food holding cabinet of claim 21, wherein the first computer obtains said address from a mother board to which the first computer is coupled.

23. The food holding cabinet of claim 1, wherein the food holding cabinet is comprised of a plurality of food holding compartments, at least one temperature control element being thermally coupled to each compartment and, a computer-controlled power supply for each element, each power supply having a unique address.

24. The food holding cabinet of claim 23, wherein the food holding cabinet is further comprised of a mother board to which the power supplies are operatively connected, and wherein the address for each power supply is determined by a position on the mother board into which a power supply is operatively connected.

25. The food holding cabinet of claim 1, further comprised of a data port coupled to the second computer, the data port being configured to enable the transfer of digital information to and from the second computer.

26. The food holding cabinet of claim 25, wherein the data port is comprised of at least one of:
a USB connector;
a SIM card connector;
an optical disk drive;
an 802.xx network interface.

27. A temperature-controlled food holding cabinet (food holding cabinet), configured to maintain food items, at a different temperatures, for a plurality of different holding times, the food holding cabinet comprised of:
a plurality of food holding compartments (compartments);
at least one electrically-powered heat transfer element (element), thermally coupled to a corresponding compartment and effectuating a temperature inside the corresponding compartment;
a computer bus, configured to carry computer signals around the food holding cabinet;
a plurality of computer-controlled power supplies (power supplies), each power supply coupled to at least one element and being comprised of:
a circuit board;
a first computer (first computer) attached to the circuit board and coupled to the bus through a first type of connector attached to the circuit board;
a first memory device coupled to the first computer and storing at least one of:
data for the first computer; and
executable program instructions for the first computer,
an electric power control device attached to the circuit board and operatively coupled to:
an electric power source;
the first computer; and
the element;
the electric power control device controlling electric power provided to the element in response to a control signal from the first computer; and
a second computer operatively coupled to a plurality of the first computers via the bus, the second computer being capable of providing a download to a plurality of first computers via the bus.

28. The food holding cabinet of claim 27, wherein the first and second computers are different types of computers.

29. The food holding cabinet of claim 27, wherein the download is comprised of data.

30. The food holding cabinet of claim 28, wherein the download is comprised of executable instructions for the first computer.

31. The food holding cabinet of claim 27, wherein the electric power control device is one of:
a semiconductor; and
an electromagnetic relay.

32. The food holding cabinet of claim 27, wherein the computer bus is further comprised of:
a mother board having a plurality of second type connectors electrically coupled to the bus;
wherein at least one of, the mother board and a second type connector provides an address to a computer-controlled power supply connected to each second type connector.

33. The food holding cabinet of claim 32, wherein the second computer is configured to:
provide a first download to a first computer at a first address; and,
provide a second download to a second computer at a second address, the first and second downloads being different from each other.

34. The food holding cabinet of claim 32, wherein the second computer is configured to:
provide a first download to a first computer at a first address; and,
provide said first download to a second computer at a second address.

35. The food holding cabinet of claim 32, wherein the food holding cabinet is configured such that a download provided to a first computer-controlled power supply and a download to a second computer-controlled power supply, are determined by first and second addresses respectively.

36. The food holding cabinet of claim 32, wherein first and second power supplies are discrete entities and wherein the food holding cabinet is configured such that a download provided to the first power supply and a download provided to the second power supply is determined by the first and second power supply identities.

37. The food holding cabinet of claim 27, wherein the second computer includes a plurality of different downloads for a plurality of different first computers.

38. The food holding cabinet of claim 27, wherein the second computer includes a plurality of different downloads for a plurality of different first computers and wherein an identity for the different downloads is transmitted over the bus.

39. The food holding cabinet of claim 27, wherein a first computer on a first power supply is different from a first computer on a second power supply.

40. The food holding cabinet of claim 27, wherein a download provided to a first power supply and a download to a second power supply, are determined by a type of food item to be held in a first compartment and a type of food item to be held in a second compartment, the first and second types of food items being different from each other.

41. The food holding cabinet of claim 32, wherein the food holding cabinet is configured such that the download provided to the first power supply and to the second power supply are determined by a type of food item to be held in a first compartment and a type of food item to be held in a second compartment, the first and second types of food items being different from each other.

42. A method of storing a plurality of different food items, at a plurality of different holding temperatures in a food holding cabinet having a plurality of different food holding compartments, each compartment's temperature being controlled by electrical energy provided to a corresponding electrical heat transfer element by a computer, each heat transfer element being controlled by program instructions executed by a first, slave computer, which is coupled to a second master computer via a bus, the method comprised of:
downloading to a first slave computer from the master computer, at least one of: a first set of data and a first set of executable program instructions.

43. The method of claim 42, further comprising the step of:
downloading to a second slave computer from the master computer, a second set of executable instructions to control a second element for a second compartment, the first and second sets of executable instructions being different from each other.

44. The method of claim 42, further comprising the step of:
downloading to the first slave computer from the master computer, a first operating parameter for a first compartment, the first operating parameter determining at least one of:
a holding temperature for the first compartment;
a holding time limit for a food item;
operational instructions;
an elapsed time for a food item held in the first compartment; and
the identity of a food item in a first compartment.

45. The method of claim 43, including the step of determining which set of instructions to download to the power supplies according to at least one operating parameter for corresponding compartments.

46. The method of claim 43, including the step of determining which set of instructions to download to the power supplies according to differences between power supplies.

47. The method of claim 42, further including the step of: receiving executable program instructions for a power supply through a data port device coupled to the master computer.

48. The method of claim 49, wherein the step of receiving executable program instructions includes the step of receiving said instructions from at least one of:
a USB port;
an optical storage device;
a magnetic storage device;
a semiconductor memory device; and
a wireless interface.
